(19) United States
(12) Patent Application Publication
(10) Pub. No.: US 2019/0386835 A1
(43) Pub. Date: Dec. 19, 2019

(54) INFORMATION PROCESSING APPARATUS, METHOD FOR CONTROLLING THE SAME, AND PROGRAM THEREFOR

(71) Applicant: CANON KABUSHIKI KAISHA, Tokyo (JP)

(72) Inventors: Naoki Tsuchitoi, Kawasaki-shi (JP); Shuichi Uruma, Kawaguchi-shi (JP)

(21) Appl. No.: 16/440,858

(22) Filed: Jun. 13, 2019

(30) Foreign Application Priority Data
Jun. 19, 2018 (JP) 2018-116344

(51) Int. Cl. H04L 9/32; H04L 29/12; H04L 9/08

(52) U.S. Cl. CPC H04L 9/3263; H04L 9/085; H04L 9/3247; H04L 61/1511

(57) ABSTRACT

There is provided an apparatus, the apparatus comprising: a regeneration unit configured to, upon a change of a network configuration of the apparatus when communication by the second communication interface is set to be enabled in addition to enabled communication by the first communication interface, regenerate a digital certificate including at least two domain names of the first communication interface and of the second communication interface; an acquisition unit configured to acquire, as a signed digital certificate, the regenerated digital certificate with a digital signature attached; and an updating unit configured to update an old signed digital certificate currently held to the acquired signed digital certificate.

### BACKGROUND OF THE INVENTION

### Field of the Invention

The aspect of the embodiments relates to an information processing apparatus that uses a digital certificate, a control method for controlling the information processing apparatus, and a program for controlling the information processing apparatus.

### Description of the Related Art

In communication between apparatuses connected via a network, a technique for encrypting a communication path has been indispensable to ensure security. General encrypted communication methods include Secure Socket Layer/Transport Layer Security (SSL/TLS) in which encryption is performed in the transport or the application layer and Security Architecture for Internet Protocol (IPSec) in which encryption is performed in the network layer, out of the seven layers in Open System Interconnection (OSI).

Encrypted communication intends to take measures against tapping through an encrypted communication path, measures against alterations on the communication path through message authentication, and measures against spoofing of a communication partner through certificate verification.

In certificate verification, the technique verifies whether a digital certificate (hereinafter referred to as a certificate) transmitted from a communication partner is indirectly attached with a digital signature by a Certificate Authority (CA). If the verification result is confirmed to be valid, it becomes possible to trust information described in the certificate. In this case, it is a premise that an apparatus subjected to certificate verification accepts the provision of a root CA certificate from a CA in advance. The transmitted certificate is attached with a signature with a secret key associated with a higher level intermediate certificate that is eventually attached with a signature with a secret key associated with the root CA certificate. The signature of the transmitted certificate is verified based on the intermediate certificate, and the signature of the intermediate certificate is confirmed based on the root CA certificate. This means that the transmitted certificate can be verified by a chain of trust.

For example, when a certain apparatus connects to a domain having a domain name (hereinafter referred to as a Domain Name System (DNS) name) “aaa.com”, there is a risk that the apparatus is connected to a connection destination other than “aaa.com” by an invalid spoof communication path, such as a man-in-the-middle (MITM) attack. However, the above-described certificate verification makes it possible to guarantee that the information described in a certificate successfully verified is trustworthy.

The value of Common Name (CN), which is a piece of information described in the certificate, indicates a server name (domain name) A description of “CN=aaa.com” as certificate information makes it possible to reliably confirm that the connection destination server is “aaa.com”.

As described above, a certificate will eventually be attached with a signature by a CA. Once a certificate is issued, it is not normally corrected. A certificate has a description of an expiration date within which the certificate can be used. However, if the expiration date of a certificate expires, it takes time and effort to regenerate the certificate. Simple Certificate Enrollment Protocol: IETF draft (SCEP) is a mechanism for regenerating a certificate with which the expiration date is automatically updated. Japanese Patent Application Laid-Open No. 2008-9924 discusses a mechanism for automatically updating the expiration date of an expired certificate.

### SUMMARY OF THE INVENTION

According to an aspect of the embodiments, an apparatus including a first communication interface and a second communication interface includes a regeneration unit configured to, upon a change of a network configuration of the apparatus when communication by the second communication interface is set to be enabled in addition to enabled communication by the first communication interface, regenerate a digital certificate including at least two domain names of the first communication interface and of the second communication interface, an acquisition unit configured to acquire, as a signed digital certificate, the regenerated digital certificate with a digital signature attached, and an updating unit configured to update an old signed digital certificate currently held to the acquired signed digital certificate.

Further features of the disclosure will become apparent from the following description of exemplary embodiments with reference to the attached drawings.

### BRIEF DESCRIPTION OF THE DRAWINGS

FIG. 1 is a block diagram schematically illustrating an information processing system including a Multi-Function Peripheral (MFP) as an information processing apparatus according to an exemplary embodiment.

FIG. 2 is a diagram illustrates a configuration of hardware and software units operating in the MFP.

FIG. 3 is a diagram illustrates a user interface (UI) for displaying a network configuration information setting screen displayed on an operation unit by a configuration setting unit.

FIG. 4 is a diagram illustrates a UI for displaying a certificate regeneration setting screen displayed on the operation unit by a regeneration setting unit.

FIG. 5 is a flowchart illustrating an operation of a network configuration detection unit.

FIG. 6 is a flowchart illustrating an operation of a digital certificate regeneration unit.

FIG. 7 is a diagram illustrates a warning screen displayed when an administrator logs in.

FIG. 8 is a flowchart illustrating another operation of the network configuration detection unit.

FIG. 9 is a diagram schematically illustrating another information processing system according to an exemplary embodiment.

FIG. 10 is a flowchart illustrating another operation of the digital certificate regeneration unit.

FIG. 11 is a diagram illustrating a UI for displaying a digital certificate list display screen.

### DESCRIPTION OF THE EMBODIMENTS

In connecting a plurality of communication interfaces in an information processing apparatus, a server name is given to each of the plurality of the communication interfaces and therefore a digital certificate is applicable to each server name is.

However, it is troublesome for a user to set a certificate at a timing when the communication interface configuration is changed. For example, a large number of information processing apparatuses may possibly cause an increase in the installation cost. A technique for automatically updating a certificate discussed in Japanese Patent Application Laid-Open No. 2008-9924 updates a certificate only when the expiration date is expired, and is not configured to solve the above-described situation.

According to the aspect of the embodiments, a resetting procedure to be performed when the network configuration of the information processing apparatus changes can be reduced by automatically regenerating a digital certificate.

According to the aspect of the embodiments, Subject Alternative Names of a digital certificate are used. For example, by adding a description of a server name “DNS Name=bbb.aaa.com” as Subject Alternative Names in addition to “CN=aaa.com”, both servers “aaa.com” and “bbb.aaa.com” become verifiable based on a certificate. The use of Subject Alternative Names enables verifying a plurality of servers.

A configuration for embodying the aspect of the embodiments will be described with reference to the accompanying drawings.

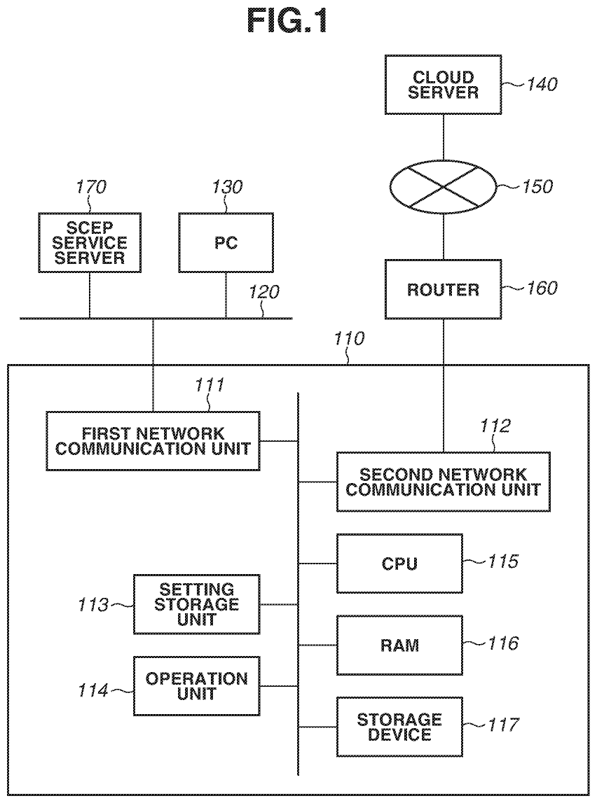

FIG. 1 is a diagram schematically illustrates an information processing system including a Multi-Function Peripheral (MFP) 110 as an information processing apparatus according to a first exemplary embodiment The information processing system illustrated in FIG. 1 includes the MFP 110, a personal computer (PC) 130, a local area network (LAN) 120, a router 160, the Internet 150, and a cloud server 140. The MFP 110 is connected with the PC 130 and a Simple Certificate Enrollment Protocol: IETF draft (SCEP) service server 170 via the LAN 120, and with the cloud server 140 via the router 160.

The SCEP service server 170 receives a certificate signature request from the MFP 110 and issues a certificate with a signature verifiable by a root Certificate Authority (CA) certificate distributed from a CA. A method for attaching a signature to a certificate through SCEP is performed according to the specifications disclosed in an IETF draft. The detailed structure of the method is not the subject of the aspect of the embodiments and will be omitted.

Current printers, MFPs, and other image forming apparatuses are provided with a server function. An image forming apparatus having a web server function is able to confirm and make setting via a browser on a PC. In communication between an image forming apparatus and a PC, Secure Sockets Layer/Transport Layer Security (SSL/TLS) may be used to secure security. Performing certificate verification based on SSL/TLS enables confirming a valid server and preventing spoofing.

Current image forming apparatuses positively advertise serviceability improved through a connection to a server, what is called a cloud, via the Internet. As an example of utilizing a cloud, remotely acquiring the use situation of an image forming apparatus enables reducing the service engineer dispatch cost. As another example, print data uploaded to a cloud is received, and a remote image forming apparatus is used for printing.

However, an image forming apparatus is not connectable with the Internet from its operating environment depending on a customer's environment, or an image forming apparatus is prohibited to directly access the Internet as a customer's operation policy. In order that the image forming apparatus utilizes a cloud under such conditions, a network different from a regular network is provided and connected to the image forming apparatus. In this case, the image forming apparatus is provided with two different predetermined communication interfaces. One communication interface connects with a LAN environment, and the other communication interface connects with the Internet, for example, via a 4th Generation (4G) public network.

In such an operating environment, the apparatus is recognized from the outside as a different server apparatus or a different client apparatus for each of the different interfaces. To perform certificate verification when each server performs SSL/TLS communication, it is possible to correctly perform certificate verification for the plurality of the communication interfaces by using the above-described Subject Alternative Names.

The MFP 110 includes a first network communication unit 111, a second network communication unit 112, a setting storage unit 113, an operation unit 114, a central processing unit (CPU) 115, a random access memory (RAM) 116, and a storage device 117. In this case, the first network communication unit 111 and the second network communication unit 112 are assumed to have physically different communication interfaces. According to the first exemplary embodiment, these communication interfaces are a first wired interface and a second wired interface, respectively, which are the above-described two different predetermined communication interfaces. Actually, in addition to a combination of wired LAN interfaces, any other combinations of communication interfaces such as wireless LAN interfaces, communication interfaces via USB interfaces, and 4G public networks are applicable. A communication interface may be simply referred to as an interface. In this way, the MFP 110 can be provided with a plurality of communication interfaces.

It is assumed that the first network communication unit connects to the LAN 120 to connect to the PC 130 used in an office. Examples of general applications of the MFP 110 by the PC 130 include an application in which the PC 130 transmits print data to the MFP 110 to perform printing, and an application in which the PC 130 receives image data scanned by the MFP 110 to display the image data. An administrator can remotely monitor the status of the MFP 110 by using a web browser application on the PC 130. In this case, certificate verification is performed to confirm that the MFP 110 is not a spoof apparatus.

Meanwhile, the second network communication unit connects to a public network via the router 160 to connect to the cloud server 140. The cloud server 140 is used to determine the service maintenance by acquiring information about the number of sheets printed by the MFP 110 and the operating status of the MFP 110. Print data output from a PC at a remote location is temporarily stored in the cloud server 140, and the MFP 110 acquires the print data and performs printing. Thus, a printing service from a remote location is offered. In any case, to confirm that the MFP 110 is a valid apparatus and is not a spoof apparatus, the cloud server 140 verifies the certificate transmitted from the MFP 110.

Each of the first and the second network communication units has a different network address for the outside and a verifiable certificate is offered for each communication. Although, in the first exemplary embodiment, the MFP 110 includes two different network communication units, the MFP 110 may include three or more different network communication units.

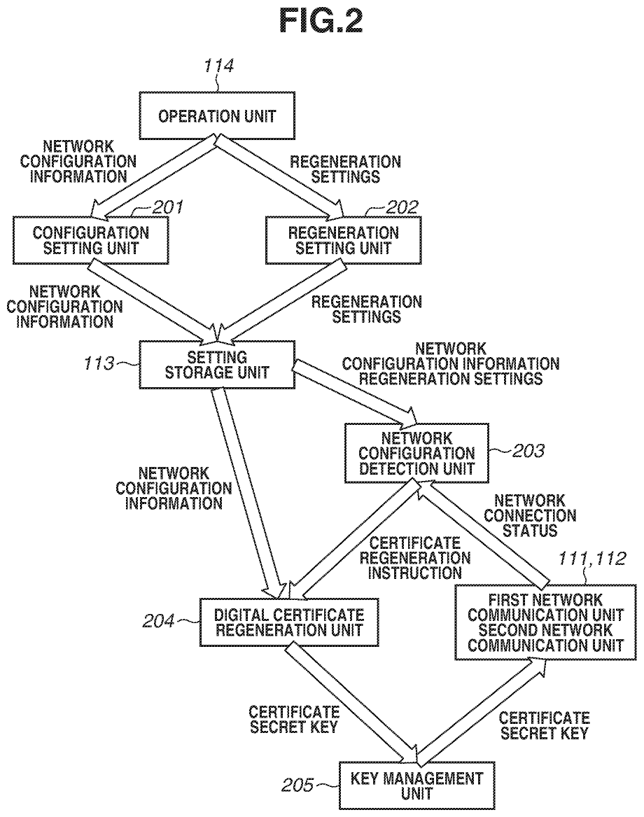

FIG. 2 is a diagram illustrating relations between hardware and software units operating in the MFP 110. Each piece of software is stored in the storage device 117 and operates when loaded into the RAM 116 and then executed by the CPU 115. In FIG. 2, the configuration setting unit 201 stores, in the setting storage unit 113, network configuration information input according to a setting screen offered on the operation unit 114. This configuration information is referred to as the network configuration information.

The regeneration setting unit 202 stores, in the setting storage unit 113, resetting information of the certificate input via the setting screen offered on the operation unit 114. By storing information input through the setting screen by the user in the setting storage unit 113 as the network configuration information and the resetting information, the information has been set to the MFP 110.

From the network configuration information and regeneration information stored in the setting storage unit 113, the network configuration detection unit 203 determines whether certificate regeneration is required based on the network connection status. When the regeneration is determined to be required, the network configuration detection unit 203 issues a certificate regeneration instruction to the digital certificate regeneration unit 204.

Upon receiving the certificate regeneration instruction, the digital certificate regeneration unit 204 acquires the network configuration information from the setting storage unit 113 and generates a key pair and a certificate. Then, the digital certificate regeneration unit 204 transmits the certificate to a SCEP server, receives the certificate as a certificate with a digital signature verifiable by a root CA certificate issued by a CA, and stores the certificate in the key management unit 205, together with the secret key of the key pair.

The key pair and the certificate stored in the key management unit 205 are taken out in SSL/TLS communication of the first network communication unit 111 and the second network communication unit 112, and are used in certificate authentication. When three or more network communication units are provided, the certificate to be regenerated corresponds to the three network communication units.

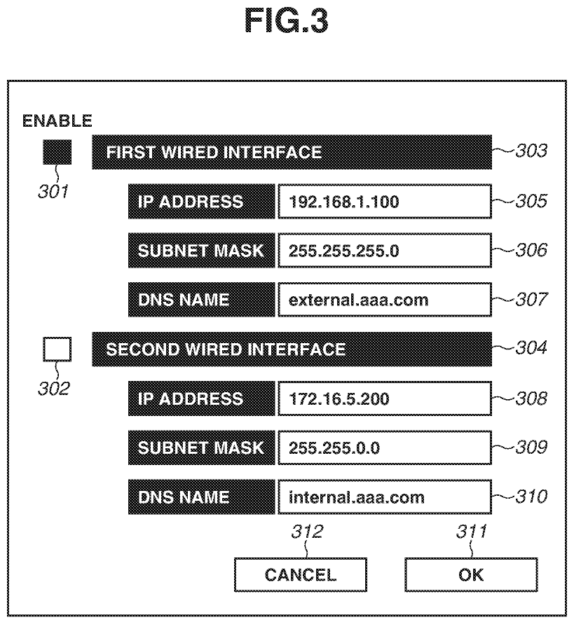

FIG. 3 illustrates a user interface (UI) for displaying a setting screen for inputting the network configuration information to be displayed on the operation unit 114 by the configuration setting unit 201. In FIG. 3, check boxes 301 and 302 are used to declare the use of the first and the second communication interfaces, respectively. FIG. 3 illustrates that the check box 301 is set to declare the use of the first wired interface. Both check boxes 301 and 302 can be simultaneously enabled. Setting both check boxes 301 and 302 means that the MFP 110 holds two or more domain names (Domain Name System (DNS) names) aspect of the embodiments.

An item 303 indicates the first wired interface (i.e., the first network communication unit 111), and an item 304 indicates the second wired interface (i.e., the second network communication unit 112). A setting 305 indicates the Internet Protocol (IP) address of the first wired interface. A setting 306 indicates the subnet mask of the first wired interface. A setting 307 indicates the DNS name of the first wired interface. These settings can be changed by the user's input. If the MFP 110 is simply provided with communication interfaces, the MFP 110 cannot exhibit a communication function. In order for the MFP 110 to exhibit the communication function, information about these communication interfaces are to be input.

Similarly, a setting 308 indicates the IP address of the second wired interface. A setting 309 indicates the subnet mask of the second wired interface. A setting 310 indicates the DNS name of the second wired interface. These settings can also be changed. An OK button 311 is used to confirm the changes of the above-described settings. A CANCEL button 312 is used to cancel the changes of the above-described settings. When the OK button 311 is pressed to change the settings, the settings changed by the configuration setting unit 201 are stored in the setting storage unit 113 as the network configuration information. When three or more interfaces are provided, network setting is performed on the three interfaces, as illustrated in FIG. 3. Even in a case of wireless interfaces, network setting is performed in a similar way to a case of wired interfaces.

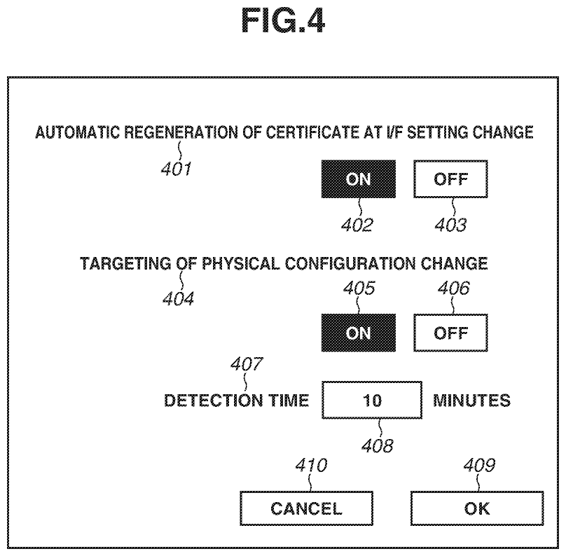

FIG. 4 illustrates a UI for displaying a setting screen for inputting conditions for certificate regeneration to be displayed on the operation unit 114 by the regeneration setting unit 202. In FIG. 4, an item 401 has a description “AUTOMATIC REGENERATION OF CERTIFICATE AT I/F SETTING CHANGE”. An “ON” setting 402 and an “OFF” setting 403 are toggle settings. When the “OFF” setting 403 is selected, the administrator or a service engineer of the MFP 110 manually make setting in a similar way to a conventional method. When the “ON” setting 402 is selected, certificate regeneration is automatically performed based on the changes of the interface configuration.

An item 404 indicates a description “TARGETING OF PHYSICAL CONFIGURATION CHANGE”. An “ON” setting 405 and an “OFF” setting 406 are toggle settings. More specifically, when the “ON” setting 405 is selected and the number of physical communication interfaces changes, the digital certificate regeneration unit 204 automatically performs certificate regeneration based on the information input through the setting screen illustrated in FIG. 3. On the other hand, when the “OFF” setting 406 is selected, a change in the number of physical communication interfaces is not targeted for certificate regeneration.

The item 404 is a sub-requirement which is set only when the “ON” setting 402 is selected for the item 401. When the “ON” setting 405 is selected for the item 404 and the physical interface configuration changes, the network configuration detection unit 203 instructs the digital certificate regeneration unit 204 to regenerate a certificate even if no setting has been made by the configuration setting unit 201. For example, even when the check box 302 is selected to enable the second wired interface, if the network is not physically connected with the second network communication unit (e.g., if a LAN cable or a radio apparatus is removed), the network configuration detection unit 203 assumes that the configuration has changed and then instructs the digital certificate regeneration unit 204 to regenerate a certificate.

However, the aspect of the embodiments is characterized in that a predetermined delay time (grace time period) is given so that a cable connection or disconnection is not regarded as an instantaneous network disconnection due to a failure of the router 160. An item 407 is used to set “DETECTION TIME” for determining a delay time (elapsed time) which can be specified in a setting 408 in units of minute. When 10 is input to the setting 408, the network configuration detection unit 203 regards a network disconnection for 10 minutes or less as a temporary failure and does not instruct the digital certificate regeneration unit 204 to regenerate a certificate. However, the network configuration detection unit 203 regards a network disconnection continues for more than 10 minutes as a network configuration change and then instructs the digital certificate regeneration unit 204 to regenerate a certificate.

An interface configuration change is checked only when a physical configuration change is targeted. Further, even if a new interface is physically added to the MFP 110, this physical configuration change is not targeted for certificate regeneration illustrated in FIG. 4 if the setting illustrated in FIG. 3 is not made to the new interface.

An OK button 409 is used to confirm the changes of the settings. A CANCEL button 410 is used to cancel the changes of the settings. When the OK button 409 is pressed to change the settings, the settings changed by the regeneration setting unit 202 are written into the setting storage unit 113.

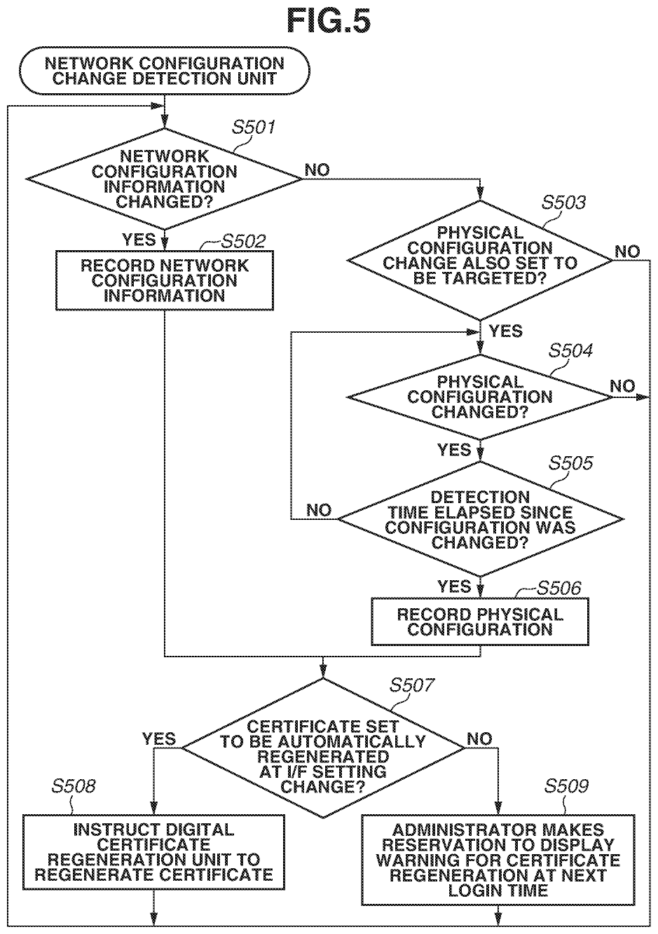

FIG. 5 is a flowchart illustrating an operation of the network configuration detection unit 203. When the MFP 110 is activated, the network configuration detection unit 203 starts operating to detect network configuration changes. The network configuration detection unit 203 continues the operation until power of the MFP 110 is turned OFF.

In FIG. 5, in step S501, the network configuration detection unit 203 confirms whether the network configuration information is changed. The network configuration detection unit 203 compares the network configuration information previously recorded in step S502 with the network configuration information recorded in the setting storage unit 113. When the two pieces of information do not coincide with each other, the network configuration detection unit 203 determines that the network configuration information is changed (YES in step S501). The change corresponds to a change of any one of the check boxes 301 and 302 and the settings 305 to 310 illustrated in FIG. 3. More specifically, when an interface is added or deleted or when an address is changed, the network configuration detection unit 203 determines that the network configuration information is changed.

When the network configuration detection unit 203 determines that the network configuration information is changed (YES in step S501), the processing proceeds to step S502. In step S502, the network configuration detection unit 203 records the network configuration information and prepares for the next comparison for setting change determination. Then, the processing proceeds to step S507. When the “ON” setting 402 is selected for the item 401 (YES in step S507), the processing proceeds to step S508. In step S508, the network configuration detection unit 203 instructs the digital certificate regeneration unit 204 to regenerate a certificate. On the other hand, when the “OFF” setting 403 is selected for the item 401 (NO in step S507), the processing proceeds to step S509. In step S509, the network configuration detection unit 203 makes a reservation so that a warning message for certificate regeneration is displayed in step S508 when the administrator logs in next time, because a re-setting is manually made. Then, the processing proceeds to step S501.

On the other hand, when the network configuration detection unit 203 determines that the network configuration information is not changed (NO in step S501), the processing proceeds to step S503. In step S503, the network configuration detection unit 203 determines whether the physical configuration change is set to be targeted. When the “ON” setting 405 is selected for the item 404 (YES in step S503), the processing proceeds to step S504. In step S504, the network configuration detection unit 203 determines whether the physical configuration has changed from the previous setting. As described above, the physical configuration change refers to a change in the number of interfaces. When the physical configuration is changed (YES in step S504), the processing proceeds to step S505. In step S505, the network configuration detection unit 203 determines whether the detection time (the value set for the setting 408) has elapsed. When the detection time has elapsed (YES in step S505), the processing proceeds to step S506. In step S506, the network configuration detection unit 203 records the physical configuration. Then, the processing proceeds to step S507. On the other hand, when the “OFF” setting 406 is selected for the item 404 (NO in step S503) or when the physical configuration is not changed (NO in step S504), the processing returns to step S501.

Although the processing for returning to step S501 forms an infinite loop in the flowchart, the network configuration detection unit 203 may wait for an event in a step prior to step S501. In this case, when the OK button 311 of the configuration setting unit 201 illustrated in FIG. 3 is pressed, an event occurs. Then, the processing proceeds to step S501. Alternatively, when the first network communication unit 111 or the second network communication unit 112 detects a physical state transition such as cable connection or disconnection, an event occurs. Then, the processing proceeds to step S501. There is no difference between a loop and an event.

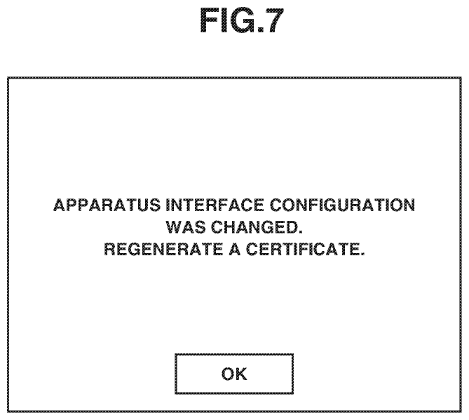

FIG. 7 illustrates a warning screen displayed when the administrator logs in. After the network configuration detection unit 203 makes a reservation in step S509 so that a warning for certificate regeneration is displayed when the administrator logs in next time, this warning screen is displayed on the operation unit 114 when the administrator actually logs in. This warning screen is intended to prompt the administrator to regenerate a certificate when automatic certificate regeneration is not performed. Certificate regeneration is performed when the user inputs a certificate regeneration instruction from a certificate regeneration instruction screen (not illustrated). However, control may be performed, for example, not to regenerate a digital certificate only when a network configuration change is stored as information.

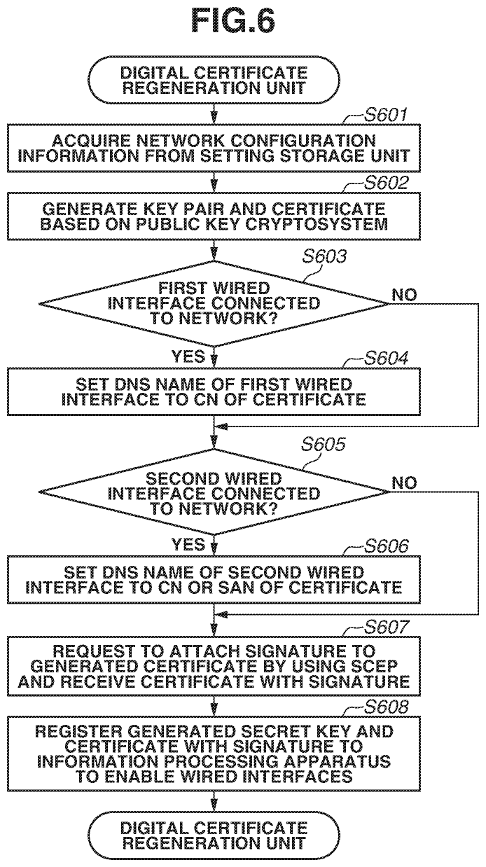

FIG. 6 is a flowchart illustrating an operation of the digital certificate regeneration unit 204. The digital certificate regeneration unit 204 operates upon reception of an instruction from the network configuration detection unit 203 and continues operating until regeneration of a certificate is completed.

In FIG. 6, in step S601, the digital certificate regeneration unit 204 acquires the network configuration information from the setting storage unit 113. In step S602, the digital certificate regeneration unit 204 generates a key pair and a certificate as a base of a certificate. The key pair is used in the public key criptosystem, either the Rivest-Shamir-Adleman (RSA) method or the elliptic curve criptosystem can be used. The public key of the generated key pair is stored in a certificate.

In step S603, the digital certificate regeneration unit 204 checks whether the first wired interface is connected to a network based on the network configuration information. When the first wired interface is connected to a network (YES in step S603), the processing proceeds to step S604. In step S604, the digital certificate regeneration unit 204 sets the value of a DNS name 307 of the first wired interface to Common Name (CN) as certificate information. If there is no DNS name, an IP address 305 can be used as a substitute.

In step S605, the digital certificate regeneration unit 204 confirms whether the second wired interface is connected to a network based on the network configuration information. When the second wired interface is connected to a network (YES in step S605), the processing proceeds to step S606. In step S606, the digital certificate regeneration unit 204 sets the value of a DNS name 310 of the second wired interface to CN or Subject Alias (SAN) as certificate information. CN is used when CN was not set in step S604, and SAN is used when CN was set in step S604 (in a certificate, CN represents only one entry and SAN represents other entries). In addition, when a DNS name is not provided, an IP address 308 may be used as a substitute.

In step S607, to attach a signature verifiable by a root CA certificate distributed from a CA to the generated certificate, the digital certificate regeneration unit 204 transmits the certificate to the SCEP service server 170 to request for a signature by using a protocol called SCEP and receives a signed certificate.

If the SCEP service is not provided, a self-certificate with a signature attached by the signature function of the MFP 110 may be used as a substitute. Although security degrades since a signature verifiable by a root CA certificate from a CA is not attached, a similar effect can be obtained. The MFP 110 acquires a signed digital certificate through either method.

In step S608, the digital certificate regeneration unit 204 registers the generated secret key and the signed certificate to the information processing apparatus to enable the wired interfaces. As a registration method, the digital certificate regeneration unit 204 updates the proved certificate before the currently held network configuration changed with the new signed certificate issued at this time. Subsequently, it becomes possible to perform certificate verification by using a certificate conforming to the network and physical configurations of the MFP 110. FIG. 6 illustrates an example of two different interfaces. When three or more different interfaces are provided, steps S605 and S606 will be executed for each interface.

As described above, according to the first exemplary embodiment, the work of the resetting procedure to be performed when the network configuration of the information processing apparatus changes can be reduced by automatically regenerating a digital certificate. In the case of an image forming apparatus such as an MFP, the procedure for changing the network configuration by a service engineer can be omitted, thus reducing the installation cost.

In the first exemplary embodiment, the DNS name may be matched between the first and the second network communication units. This matching may occur, for example, when the first network communication unit is a wired LAN interface and the second network communication unit is a wireless LAN interface. Although, even in such a case, a certificate is regenerated according to the first exemplary embodiment, it is not desirable for the following reason. Specifically, the CPU 115 is used for regeneration processing to access the storage device 117, possibly causing a decrease in processing speed of other functions concurrently executed on the MFP 110 and a degradation of the storage device 117.

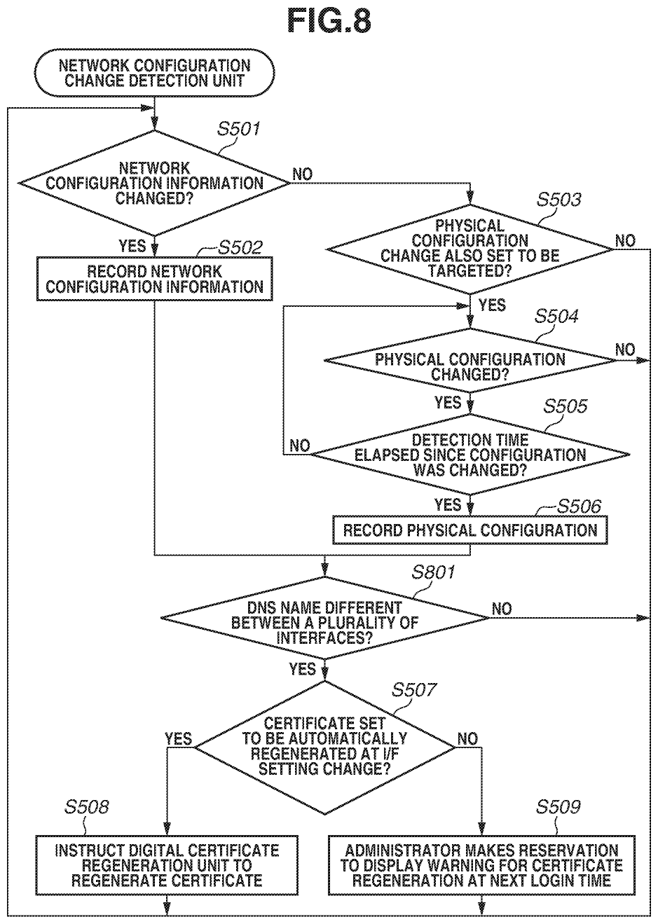

FIG. 8 is a flowchart illustrating an operation performed by the network configuration detection unit 203 to solve this issue. The flowchart illustrated in FIG. 8 is based on the flowchart illustrated in FIG. 5 and differs therefrom only in that step S801 is added. Only the difference from the flowchart illustrated in FIG. 5 is described below.

Steps S501 to S507 in which the network or physical configuration has changed are similar to the same steps according to the first exemplary embodiment. According to a second exemplary embodiment, in step S801 prior to step S507, the digital certificate regeneration unit 204 confirms whether the DNS name differs between a plurality of interfaces. When the DNS name is mismatched between the plurality of the interfaces (YES in step S801), the processing proceeds to step S507 like the first exemplary embodiment. On the other hand, when the DNS name is matched between the plurality of the interfaces (NO in step S801), the digital certificate regeneration unit 204 does not generate a certificate. Then, the processing returns to step S501.

As described above, according to the second exemplary embodiment, the work of the resetting procedure to be performed when the network configuration of the information processing apparatus changes can be reduced by automatically regenerating a digital certificate. In addition, it is possible to prevent the influence on the execution of other functions of the information processing apparatus and prevent the degradation of the hardware thereof.

The method according to the first exemplary embodiment can be performed without problem when the DNS names of the first and the second network communication units are in a sub-domain relation. The sub-domain relation refers to a relation in which, for example, one DNS name is “aaa.com” and the other DNS name is “bbb.aaa.com”.

However, when the DNS names of the first and the second network communication units are not in a sub-domain relation, for example, when the DNS names are “aaa.com” and “bbb.com”, a problem arises when the first exemplary embodiment is embodied. In this case, “aaa.com” is set to CN of the certificate and “bbb.com” is set to SAN thereof. However, setting two different domains unrelated with each other in a certificate in this way is contrary to the meaning of the certificate for proving the validity of the connection destination.

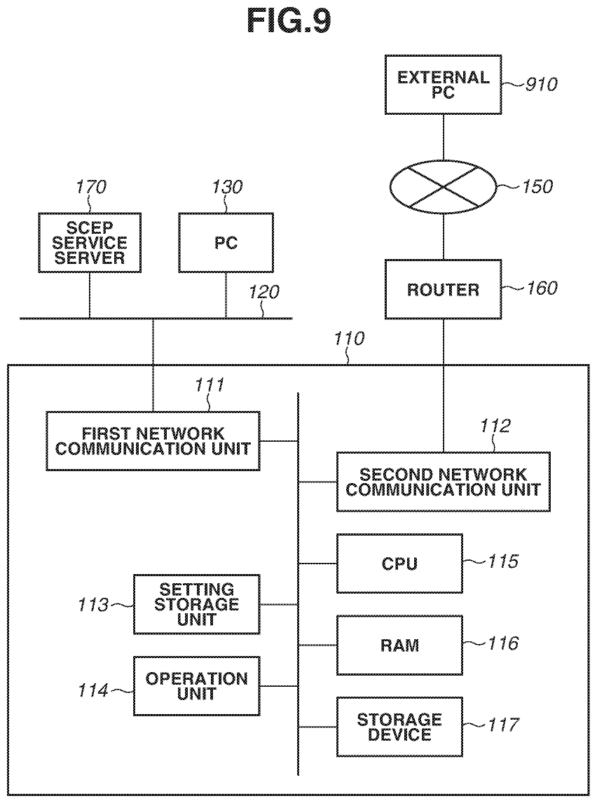

A network configuration having two different interfaces not in a sub-domain relation is often seen, for example, in municipal offices. This configuration is intended to take measures against personal information leakage. In this case, as illustrated in FIG. 9, the MFP 110 communicates with the PC 130 in a municipal office and an external PC 910 outside the municipal office. The system configuration illustrated in FIG. 9 differs from the system configuration illustrated in FIG. 1 in that the cloud server 140 is replaced with the external PC 910. In the above-described network configuration, when an external user accesses the MFP 110 from the external PC 910 and two completely different domains are included in a certificate, there arises a problem that the external user may distrust the validity of the certificate. To avoid such a distrust, a certificate through manual operations is generated, and therefore the method according to the first exemplary embodiment cannot be used.

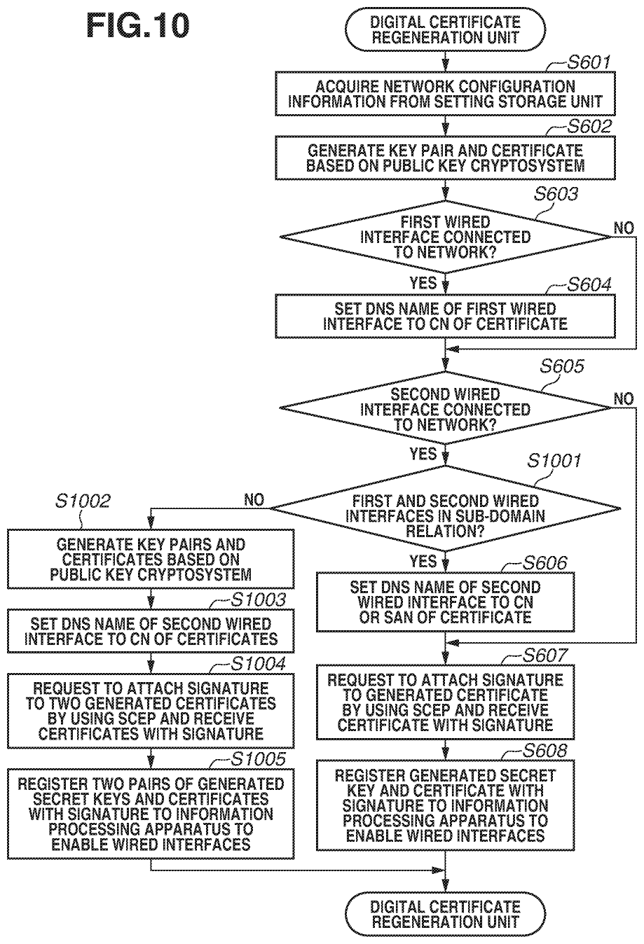

A third exemplary embodiment is a method for solving the above-described problem. An operation of the digital certificate regeneration unit 204 for this purpose will be described below with reference to the flowchart illustrated in FIG. 10. Other operations and configurations are similar to those of the first exemplary embodiment.

The flowchart illustrated in FIG. 10 is based on the flowchart illustrated in FIG. 6 and differs therefrom in that steps S1001, 1002, 1003, 1004, and 1005 are added. Thus, only the difference from the flowchart illustrated in FIG. 6 is described below.

Steps S601 to S606 are similar to the same steps according to the first exemplary embodiment. In step S1001 prior to step S606, the digital certificate regeneration unit 204 determines whether the first and the second wired interfaces are in a sub-domain relation. The determination is performed by using the DNS names of the respective interfaces acquired from the setting storage unit 113. More specifically, the digital certificate regeneration unit 204 removes defined domain names such as “.com” and “.co.jp” from the respective DNS names When the rightmost portions of the remaining character strings are matched, the digital certificate regeneration unit 204 determines that the first and the second wired interfaces are in a sub-domain relation. For example, “aaa.com” and “bbb.aaa.com” are in a sub-domain relation. “bbb.aaa.com” and “ccc.aaa.com” are also in a sub-domain relation. However, “aaa.com” and “bbb.com” are not in a sub-domain relation.

When the digital certificate regeneration unit 204 determines that the first and the second wired interfaces are in a sub-domain relation (YES in step S1001), the processing proceeds to step S606. In step 606 and subsequent steps, the digital certificate regeneration unit 204 performs similar operations to those of the first exemplary embodiment.

On the other hand, when the digital certificate regeneration unit 204 determines that the first and the second wired interfaces are not in a sub-domain relation (NO in step S1001), the processing proceeds to step S1002. In step S1002 and subsequent steps, the digital certificate regeneration unit 204 generates a key pair based on the public key criptosystem and a certificate. As a result, two pairs of keys and certificates, including the key pair and certificate regenerated in step S602, have been generated.

In step S1003, the digital certificate regeneration unit 204 inputs the DNS name 310 of the second wired interface to CN of the certificate generated in step S1002.

In step S1004, the digital certificate regeneration unit 204 transmits the two generated certificates to the SCEP service server 170 to request to attach a signature by using the SCEP protocol and receives the certificate with a signature attached (signed certificate).

In step S1005, the digital certificate regeneration unit 204 registers two pairs of secret keys and signed certificates to the information processing apparatus to enable the wired interfaces. In this case, the certificate generated in step S602 with a signature attached is used for the first wired interface, and the certificate generated in step S1002 with a signature attached is used for the second wired interface.

The third exemplary embodiment largely differs from the first exemplary embodiment in that a certificate is generated for each interface. Since the number of certificates increases with increasing number of interfaces, the present exemplary embodiment may possibly cause an increase in the management cost for the MFP 110, for example, the cost for checking whether only suitable certificates are registered to the MFP 110. The following additional processing may be performed to avoid this cost increase.

When the network configuration detection unit 203 detects a decrease in the number of interfaces, the network configuration detection unit 203 identifies a removed interface based on the network or physical configuration information stored in the setting storage unit 113. Then, the network configuration detection unit 203 deletes the certificate registered for the identified interface from the MFP 110. As a result, only certificates to be used are registered in the MFP 110.

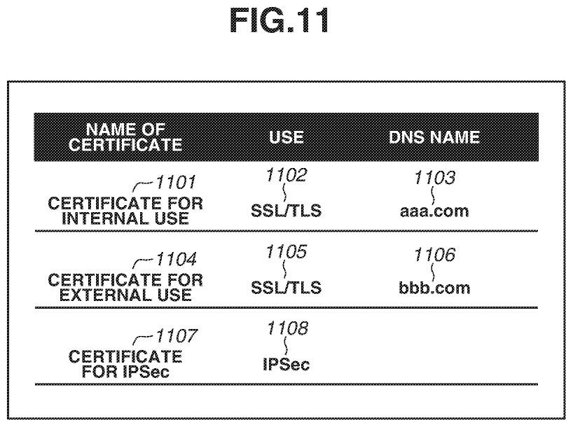

The information processing apparatus generally has a screen for displaying a list of digital certificates registered in the information processing apparatus. Such a list display screen is typically configured to display a list of the names of certificates. When any one of the names is selected, another screen appears to display detailed information (e.g., an expiration date) of the selected certificate. In many cases, the list display screen also displays the intended use of the selected certificate. The intended use refers to a function for which the certificate is to be used. For example, a certificate may be used for an encrypted communication function called Security Architecture for Internet Protocol (IPSec) in addition to SSL/TLS. Applying the present exemplary embodiment in this screen configuration causes an issue that a plurality of certificates for SSL/TLS exists, making it difficult for the user to recognize which certificate is for which interface until a detailed information screen for the certificates appears. This issue can be solved by displaying the DNS names in the certificate list screen, as illustrated in FIG. 11. FIG. 11 illustrates an example where three different certificates are displayed. Items 1101, 1104, and 1107 denote the names of the certificates, items 1102, 1105, and 1108 denote the intended uses of the certificates, and items 1103 and 1106 are the DNS names set to CN of the certificates. This screen configuration enables the user to obviously recognize which certificate is for which interface.

As described above, according to the third exemplary embodiment, the work of the re-setting procedure to be performed when the network configuration of the information processing apparatus changes can be reduced by automatically regenerating a digital certificate. In addition, it is possible to prevent the user of the information processing apparatus from having a distrust and prevent the increase in the management cost therefor.

### Other Embodiments

Embodiments of the disclosure can also be realized by a computer of a system or apparatus that reads out and executes computer executable instructions recorded on a storage medium (e.g., non-transitory computer-readable storage medium) to perform the functions of one or more of the above-described embodiment(s) of the disclosure, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-116344, filed Jun. 19, 2018, which is hereby incorporated by reference herein in its entirety.

What is claimed is:

1. An apparatus including a first communication interface and a second communication interface, the apparatus comprising:
a regeneration unit configured to, upon a change of a network configuration of the apparatus when communication by the second communication interface is set to be enabled in addition to enabled communication by the first communication interface, regenerate a digital certificate including at least two domain names of the first communication interface and of the second communication interface;
an acquisition unit configured to acquire, as a signed digital certificate, the regenerated digital certificate with a digital signature attached; and
an updating unit configured to update an old signed digital certificate currently held to the acquired signed digital certificate.

2. The apparatus according to claim 1, wherein, in a case where the digital certificate is set not to be regenerated in the apparatus even when the network configuration of the apparatus is changed, the regeneration unit does not regenerate the digital certificate.

3. The apparatus according to claim 2, wherein the regeneration unit displays, in a case where the regeneration unit does not regenerate the digital certificate even when the network configuration of the apparatus is changed, a message for prompting a regeneration of the digital certificate when a user logs in next time.

4. The apparatus according to claim 1, further comprising a provision unit configured to provide a network configuration information setting screen for inputting information including a domain name for each of the plurality of the communication interfaces included in the apparatus,
wherein the regeneration unit regenerates the digital certificate based on the information including domain names input via the network configuration information setting screen by a user.

5. The apparatus according to claim 4,
wherein the provision unit further provides a regeneration setting screen for inputting conditions for regenerating the digital certificate by the regeneration unit, and
wherein the regeneration unit controls whether to regenerate the certificate based on the regeneration conditions input via the regeneration setting screen by the user.

6. The apparatus according to claim 4, wherein conditions for regenerating the digital certificate include as a condition of the regeneration in a case where a number of communication interfaces usable by the apparatus changes in addition to a case where the information is input via the network configuration information setting screen by the user.

7. The apparatus according to claim 6, wherein, in a case where the regeneration when the number of communication interfaces changes is included as a condition, an elapsed time since the number of communication interfaces changes is further included as a condition for the regeneration.

8. The apparatus according to claim 1, wherein the acquisition unit acquires, by transmitting the regenerated digital certificate and a key pair to a certificate authority, together with a signature request for the digital certificate, the signed digital certificate attached with a signature and transmitted by the certificate authority.

9. A method for controlling an apparatus including a first communication interface and a second communication interface, the method comprising:
regenerating, upon a change of a network configuration of the apparatus when communication by the second communication interface is set to be enabled in addition to enabled communication by the first communication interface, a digital certificate including at least two domain names of the first communication interface and of the second communication interface;
acquiring, as a signed digital certificate, the digital certificate regenerated by the regenerating with a digital signature attached; and
updating a currently held old signed digital certificate to the acquired signed digital certificate.

10. The method according to claim 9, wherein, in a case where the digital certificate is set not to be regenerated in the apparatus even when the network configuration of the apparatus is changed, the regenerating does not regenerate the digital certificate.

11. The method according to claim 9, further comprising providing a network configuration information setting screen for inputting information including a domain name for each of the plurality of the communication interfaces included in the apparatus,
wherein the regenerating regenerates the digital certificate based on the information including domain names input via the network configuration information setting screen by a user.

12. The method according to claim 9, wherein the acquiring acquires, by transmitting the digital certificate regenerated by the regenerating and a key pair to a certificate authority, together with a signature request for the digital certificate, the signed digital certificate attached with a signature and transmitted by the certificate authority.

13. A computer readable-storage medium storing a computer-executable program of instructions for causing a computer to perform a method for controlling an apparatus including a first communication interface and a second communication interface, the method comprising:
regenerating, upon a change of a network configuration of the apparatus when communication by the second communication interface is set to be enabled in addition to enabled communication by the first communication interface, a digital certificate including at least two domain names of the first communication interface and of the second communication interface;
acquiring, as a signed digital certificate, the digital certificate regenerated by the regenerating with a digital signature attached; and
updating a currently held old signed digital certificate to the acquired signed digital certificate.

14. The computer readable-storage medium according to claim 13, wherein, in a case where the digital certificate is set not to be regenerated in the apparatus even when the network configuration of the apparatus is changed, the regenerating does not regenerate the digital certificate.

15. The computer readable-storage medium according to claim 13, further comprising providing a network configuration information setting screen for inputting information including a domain name for each of the plurality of the communication interfaces included in the apparatus,
wherein the regenerating regenerates the digital certificate based on the information including domain names input via the network configuration information setting screen by a user.

16. The computer readable-storage medium according to claim 13, wherein the acquiring acquires, by transmitting the digital certificate regenerated by the regenerating and a key pair to a certificate authority, together with a signature request for the digital certificate, the signed digital certificate attached with a signature and transmitted by the certificate authority.

17. The information processing apparatus according to claim 1, wherein, in a case where the domain names set in the apparatus do not change even when the network configuration of the apparatus is changed, the regeneration unit does not regenerate the digital certificate.

18. An apparatus including a first communication interface and a second communication interface, the apparatus comprising:
a regeneration unit configured to, when a network configuration of the apparatus is changed when communication by the second communication interface is set to be enabled in addition to enabled communication by the first communication interface, regenerate a digital certificate including a domain name of the first communication interface and further regenerate a digital certificate including a domain name of the second communication interface;
an acquisition unit configured to acquire, as a signed digital certificate, the regenerated digital certificate with a digital signature attached; and
a registration unit configured to register the acquired signed digital certificate so as to be registered corresponding to each communication interface.

19. The apparatus according to claim 18, wherein, in a case where the number of communication interfaces usable by the information processing apparatus changes, the digital certificate corresponding to a reduced communication interface is deleted.

20. The apparatus according to claim 18, further comprising a display unit configured to display a list of digital certificates registered in the apparatus,
wherein the display unit displays the domain name set for a communication interface corresponding to each digital certificate, together with the name of the digital certificate.
